(19) United States
(12) Patent Application Publication
(10) Pub. No.: US 2010/0049991 A1
(43) Pub. Date: Feb. 25, 2010

(54) SAFE SELF-DESTRUCTION OF DATA

(75) Inventors: Lior Frenkel, Misgav Dov (IL); Amir Zilberstein, Yad Rambam (IL)

Correspondence Address: D. Kligler I.P. Services LTD, P.O. Box 25, Zippori, 17910, IL

(73) Assignee: GITA TECHNOLOGIES LTD, Rosh HaAyin (IL)

(21) Appl. No.: 12/595,522

(22) PCT Filed: May 6, 2008
(86) PCT No.: PCT/IL2008/000623

§ 371 Date: Oct. 12, 2009

(30) Foreign Application Priority Data
May 6, 2007 (IL) 183024

(51) Int. Cl. G06F 12/14; G06F 12/00

(52) U.S. Cl. 713/193; 711/163; 711/E12.001; 711/E12.092

(57) ABSTRACT

A method for securing data includes encrypting the data and storing a key (54) for deciphering the encrypted data in a volatile memory (56) coupled to a power source (62). In response to an event indicative of a vulnerability of the data to unauthorized exposure, the power source is disconnected from the volatile memory.

### FIELD OF THE INVENTION

The present invention relates to data security, and, more specifically, to the protection of program code and operating data.

### BACKGROUND OF THE INVENTION

Valuable information is frequently encrypted so as to prevent or hinder unauthorized access. Encryption is only useful, however, if the associated cryptographic keys are also protected. A standard for cryptographic key protection has been published by the United States National Institute of Standards and Technology (NIST) as the “Federal Information Processing Standards Publication (FIPS PUB) 140-2: Security Requirements for Cryptographic Modules,” which is incorporated herein by reference.

Hardware devices for the protection of cryptographic keys and of other critical security parameters (CSPs) are generally referred to as hardware security modules (HSMs). CSPs may include private keys used in public-key cryptography, as well as symmetric keys and passwords. Many HSMs have processing capabilities for performing cryptographic tasks. Typically, CSPs cannot be extracted from the HSMs in an unencrypted form (also referred to as a plaintext form). For backup purposes, CSPs may be removed from HSMs in encrypted form.

Commercial HSMs include:
the Host Security Module 8000 by Thales, described at www.thales-esecurity.com/productsservices;
the DEP/T6 Data Encryption Peripheral by Banksys (Brussels), described at www.banksys.com/bkscomwt/EN/Products_and_solutions/Hardware_security_modules/DEPT6/index.jsp;
the Sun Crypto Accelerator 6000 adapter (SCA6000), by Sun Microsystems, described at www.sun.com/products/networking/sslaccel/suncryptoaccel6000/index.xml; and
the 4764 PCI-X Cryptographic Coprocessor by IBM, described at www-03.ibm.com/security/cryptocards/pcixcc/overhardware.shtml.
   The IBM 4764 module “incorporates physical penetration, power, and temperature sensors to detect physical attacks against the encapsulated subsystem.”

An Unmanned Aerial Vehicle (UAV), when designed for military reconnaissance, is often equipped with a mechanism for physical self-destruction in order to prevent highly confidential equipment and data from being acquired by an enemy. According to the website www.aeronautics.ru, an early Soviet Union UAV, the Tu-123, was designed to self-destruct by shutting down its own engine, thereby causing itself to crash. Modern methods of self destruction including on-board explosives are described in Smart Weapons: Top Secret History of Remote Controlled Airborne Weapons, by Hugh McDaid and David Oliver (Welcome Rain Press, New York, N.Y. 2000).

### SUMMARY OF THE INVENTION

Embodiments of the present invention provide methods and apparatus for preventing unauthorized access to valuable data by making the data inaccessible when a vulnerability, such as a threat to data security, is sensed.

In some embodiments, valuable data, such as program code and/or acquired data, is encrypted, and the associated cryptographic key is retained in volatile memory, such as random access memory (RAM). The volatile memory can retain the key only while connected to a power source. When a threat to the security of the data arises (meaning an event that could lead to exposure of the data), a trigger disconnects the power source from the memory. Consequently, the key in the memory is lost, and the data can no longer be accessed.

There is therefore provided, in accordance with an embodiment of the present invention, a method for securing data including:

encrypting the data;

storing a key for deciphering the encrypted data in a volatile memory coupled to a power source; and

in response to an event indicative of a vulnerability of the data to unauthorized exposure, disconnecting the power source from the volatile memory.

Typically, disconnecting the power source includes receiving a signal indicative of the possible exposure and disconnecting the power source responsively to the signal. Receiving the signal may include sensing one or more of an environmental parameter, a circuit component failure, and an unauthorized intrusion.

In some embodiments, the volatile memory is a first memory, and the method includes storing the encrypted data in a second memory.

The data may include program code, and the method may include decrypting the program code using the key and passing the decrypted program code to a processor for execution.

The volatile memory may be coupled to the power source by a switch, in which case disconnecting the power source includes opening the switch.

In some embodiments, disconnecting the power source includes providing a logical low output from a logical switch.

There is further provided, in accordance with an embodiment of the present invention, apparatus for securing data including:

a volatile memory operative to store a cryptographic key;

a processor, which is operative to read encrypted data and to decrypt the data using the cryptographic key in the volatile memory;

a power source; and

a switch, which is coupled between the power source and the volatile memory and is operative, in response to an event indicative of a vulnerability of the data to unauthorized exposure, to disconnect the power source from the volatile memory.

Typically, the switch is operative to disconnect the power source upon receiving a signal indicative of the possible exposure.

In some embodiments, the switch includes a relay contact.

The switch may be operative to disconnect the power source upon receiving a logical low output from a sensor.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system in which a control unit may be configured to protect data against enemy access, in accordance with an embodiment of the present invention; and

FIG. 2 is a block diagram that schematically illustrates a control unit that protects valuable data, in accordance with an embodiment of the present invention.

### DETAILED DESCRIPTION OF EMBODIMENTS

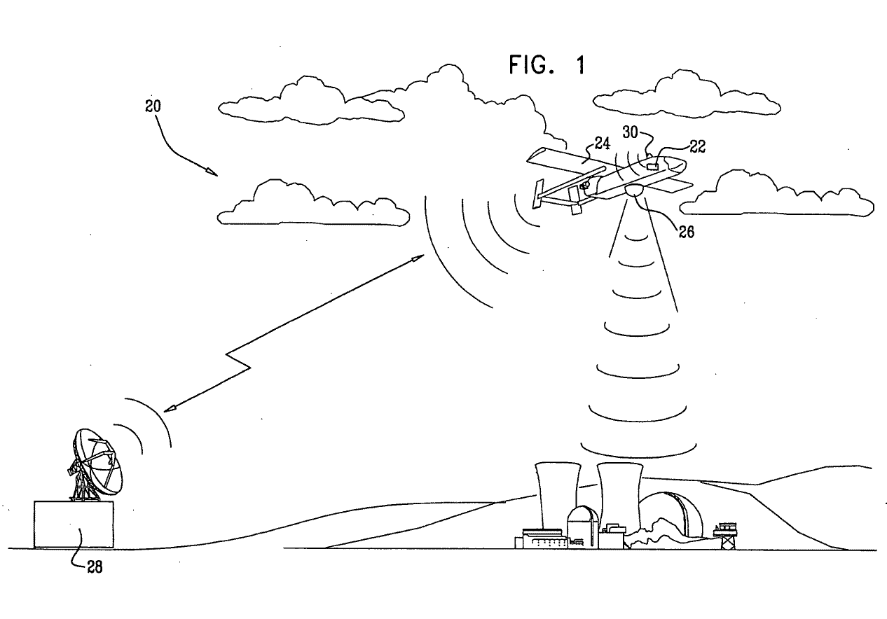

FIG. 1 is a schematic, pictorial illustration of a system 20 in which a control unit 22 performs data acquisition and computing functions. Control unit 22 is shown as being on board an unmanned aerial vehicle (UAV) 24.

In some embodiments, data acquisition by control unit 22 is performed during military reconnaissance operations. Reconnaissance may include image acquisition by a camera 26, as well as acquisition of environmental measures, such as temperature and humidity and other atmospheric parameters.

Typically, control unit 22 is configured to receive commands, such as navigation instructions, from a command center 28. Control unit 22 may transmit images and other acquired data to command center 28 in real time, by means of a transmitter/receiver 30. Alternatively or additionally, computing and data acquisition functions may be performed without real time communications, and control unit 22 may operate in an autonomous manner, performing tasks based solely on internally programmed code.

Both the program code and the acquired data are forms of valuable data that must be protected against unauthorized access. When a vulnerability or susceptibility to data exposure is sensed, control unit 22 causes the data to become irretrievable, as described further hereinbelow. The protection against unauthorized access, referred to hereinbelow as data self-destruction, is an alternative, or complement, to physical self-destruction that is often employed in the military context described above.

Although the pictured embodiment refers, by way of example, to a particular application in UAV 24, the principles of the present invention may similarly be applied in other applications in which data and/or program code must be protected from falling into unauthorized hands. These principles may be applied not only in military and security-related fields, but also to computing devices in non-military environments, including commercial computers, that must provide active means for protecting valuable data.

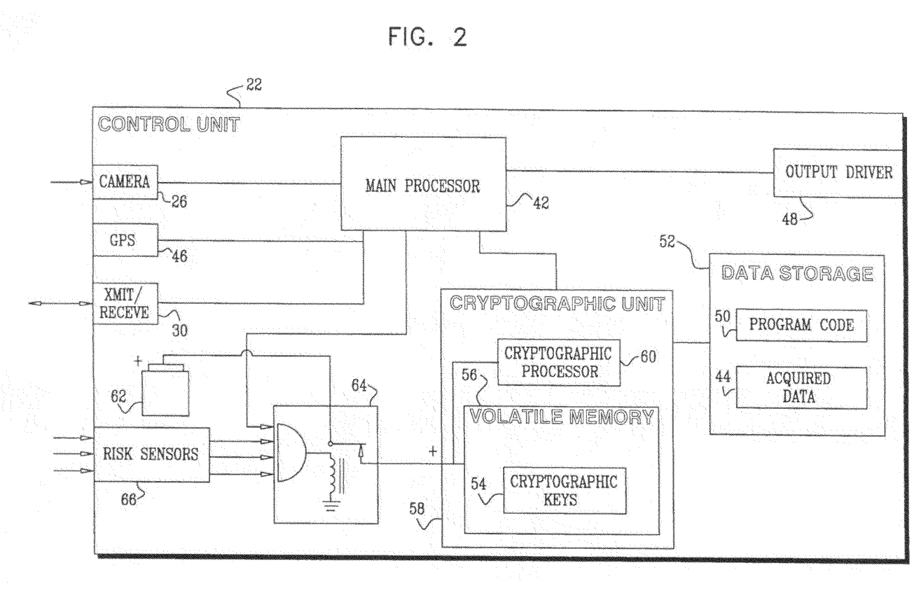

FIG. 2 is a block diagram that schematically illustrates elements of a control unit 22 configured to prevent unauthorized access to data, in accordance with an embodiment of the present invention.

A main processor 42 of control unit 22 performs data control operations, such as reception of acquired data 44 from camera 26 and generation of output signals. Some or all of the operations performed by control unit 22 are determined by program code 50. Acquired data 44 may also include location coordinates from a global positioning system (GPS) receiver 46. Output signals generated by main processor 42 may be transmitted through an output driver 48 to control the path and operation of UAV 24. Main processor 42 may also communicate with command center 28 over transmitter/receiver 30.

Program code 50 and/or acquired data 44 are encrypted and stored in a data storage area 52. Data storage area 52 may be implemented using any data storage technology, including hard disks, solid state memory such as flash memory or random access memory (RAM), compact disks, and magnetic tapes. Data storage area 52 may therefore be understood as comprising either volatile or non-volatile memory, and furthermore may comprise multiple homogeneous or heterogeneous types of storage.

A cryptographic processor 60 encrypts all data sent from main processor 42 to data storage area 52 and decrypts all data read by main processor 42 from data storage area 52, including program code 50.

The cryptographic processor is typically comprised in a cryptographic unit 58, which also maintains one or more cryptographic keys 54. The cryptographic processor may execute a publicly-known cryptographic algorithm, such as the triple Data Encryption Standard (3DES) or the Advanced Encryption Standard (AES), or may execute a proprietary cryptographic algorithm. The cryptographic keys for performing the abovementioned cryptographic functions are stored in a volatile memory 56 of the cryptographic unit.

Operation of control unit 22 is initialized by several steps including: encrypting and storing program code 50 in data storage area 52, connecting volatile memory 56 to a power source, and loading the cryptographic keys into the volatile memory. Initial encryption of program code 50 may be performed by cryptographic unit 58 or by an external processor.

Cryptographic unit 58 may be implemented as a single hardware module, such that elements comprised in the cryptographic unit are powered by a common power source such as a battery 62. Battery 62 is coupled to the cryptographic unit through a switch, indicated in FIG. 2 by way of example as a logical AND switch 64. Switch 64 serves to receive several inputs and, if the inputs indicate that a set of necessary conditions are met, to output a logical high voltage. Switch 64 may be implemented as an integrated circuit (IC) logic device, such as a logical AND gate or a programmable logic array (PLA), or as a circuit gate comprising an electromagnetic or solid state relay. Those skilled in the art may utilize alternative technologies to implement switch 64, depending on the environment and application of control unit 22.

Cryptographic unit 58 also may be implemented by alternative technologies and configurations. For example, cryptographic processor 60 may comprise separate processors, one for encryption and a second for decryption. In addition, cryptographic processor 60 may be physically distinct from volatile memory 56, in which case the output of switch 62 is coupled directly to volatile memory 56 and the cryptographic processor may receive power from a separate source. Furthermore, the logical functions of cryptographic processor 60 and of main processor 42 may be performed by a single physical processing unit (which may itself comprise multiple processors).

During normal operation of control unit 22, output of switch 64 is maintained at a logical high voltage, which provides sufficient power to operate volatile memory 56. The logical high voltage is also referred to hereinbelow as a closed-switch setting, as this setting is the equivalent of a relay contact being closed so as to couple the battery directly to the cryptographic unit. On the other hand, a logical low output, which is essentially a zero voltage output, effectively means that the battery is disconnected from volatile memory 56. The logical low setting of the switch is therefore referred to hereinbelow as an open-switch setting. In the open-switch setting, the contents of the volatile memory are lost, as the volatile memory no longer receives power.

The setting of switch 64 is determined by inputs from one or more vulnerability sensors 66, which measure the vulnerability of control unit 22 to unauthorized access. When sensors 66 are all operational and measure levels of vulnerability within predetermined safety ranges, these sensors provide logical inputs to switch 64 that cause the output of switch 64 to be high (switch closed). In some embodiments of the present invention, sensors 66 measure environmental parameters, such as altitude, speed, location, and temperature of the UAV. When any of these parameters are outside a predetermined safety range, thereby indicating a threat, or vulnerability, the corresponding sensor will send a signal to switch 64 causing the switch to open. For example, parameters that may be set to indicate vulnerability include a low flight altitude, an exceptional speed, a deviation from a planned flight route, or other possible indications of an impending crash. When switch 64 is configured as a logical AND gate, a sensor detecting an out-of-range parameter provides a logical low signal to the switch, thereby causing the switch to disconnect power from the cryptographic unit

When power is disconnected from cryptographic unit 58, the contents of volatile memory 56, including keys 54, are immediately lost. Consequently, it is no longer possible to decrypt the encrypted contents of data storage area 52. The encrypted data are therefore inaccessible, and control unit 22 has effectively performed data self-destruction. In some embodiments, control unit 22 is no longer operational after performing data self-destruction, as program code also becomes inaccessible.

Additionally or alternatively, power may be disconnected from the volatile memory by other means and due to other failure-related or threat related causes. For example, the power may be disconnected upon command by an operator of the UAV. As another example, failure of a sensor, or of switch 64 itself, also causes a logical low switch output to the cryptographic unit.

In a further embodiment, additional logical inputs to switch 64 are provided by main processor 42 and by other circuit components within control unit 22 to signal a failure of any of these components. Additional vulnerabilities that may be triggered by main processor 42 or other control unit elements may include loss of communications with command center 28 and reception from the command center of a specific command to cause data self-destruction. Data self-destruction may be implemented in addition to the implementation of more physical forms of self-destruction, such as physical explosion, which may be caused by an internal explosive device (not shown). Furthermore, upon destruction of the UAV (due to crash landing or explosion of such an explosive device, for example), it is likely that the power will be disconnected anyway, thus preventing unauthorized persons from salvaging and accessing the data or program code that may still be stored in non-volatile memory.

In some embodiments, each UAV mission may begin with a random generation of cryptographic keys, which are then preserved only in control unit 22. Consequently, data self-destruction is permanent, in that there is no means for reconstructing data in data storage area 52 subsequent to the disconnection of power from the cryptographic unit. In alternative embodiments, operators of control unit 22 may save a copy of the cryptographic keys, such that the data, while inaccessible to an enemy, can be reconstructed if the UAV is recovered by the operators.

In some embodiments of the present invention (including non-UAV embodiments), vulnerability sensors may be configured to sense indications of unauthorized intrusion that may threaten data security. For example, vulnerability sensors may be configured to sense a forced entrance to a computing facility or to sense tampering with an enclosure of the control unit itself.

The principles of the present invention may also be applied in the context of other computing or data acquisition environments, such as commercial or scientific computing operations and in the context of other communications technologies. It will thus be appreciated that embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for securing data comprising:
encrypting the data;
storing a key for deciphering the encrypted data in a volatile memory coupled to a power source; and
in response to an event indicative of a vulnerability of the data to unauthorized exposure, disconnecting the power source from the volatile memory.

2. The method according to claim 1, wherein disconnecting the power source comprises receiving a signal indicative of the possible exposure and disconnecting the power source responsively to the signal.

3. The method of claim 2, wherein receiving the signal comprises sensing an environmental parameter.

4. The method of claim 2, wherein receiving the signal comprises sensing a circuit component failure.

5. The method of claim 2, wherein receiving the signal comprises sensing an unauthorized intrusion.

6. The method of claim 1, wherein the volatile memory is a first memory, and comprising storing the encrypted data in a second memory.

7. The method of claim 1, wherein the data comprise program code, and comprising decrypting the program code using the key and passing the decrypted program code to a processor for execution.

8. The method of claim 1, wherein the volatile memory is coupled to the power source by a switch and wherein disconnecting the power source comprises opening the switch.

9. The method of any of claims 1-7 claim 1, wherein disconnecting the power source comprises providing a logical low output from a logical switch.

10. Apparatus for securing data comprising:
a volatile memory operative to store a cryptographic key;
a processor, which is operative to read encrypted data and to decrypt the data using the cryptographic key in the volatile memory;
a power source; and
a switch, which is coupled between the power source and the volatile memory and is operative, in response to an event indicative of a vulnerability of the data to unauthorized exposure, to disconnect the power source from the volatile memory.

11. The apparatus of claim 10, wherein the switch is operative to disconnect the power source upon receiving a signal indicative of the possible exposure.

12. The apparatus of claim 11, wherein the signal comprises an indication of an environmental parameter.

13. The apparatus of claim 11, wherein the signal comprises an indication of a circuit component failure.

14. The apparatus of claim 11, wherein the signal comprises an indication of an unauthorized intrusion.

15. The apparatus of claim 10, wherein the volatile memory is a first memory, and comprising a second memory operative to store the encrypted data.

16. The apparatus of claim 10, wherein the data comprise program code, and wherein the processor is operative to decrypt the program code using the key, and to pass the decrypted program code to another processor for execution.

17. The apparatus of claim 10, wherein the switch comprises a relay contact.

18. The apparatus of claim 10, wherein the switch is operative to disconnect the power source upon receiving a logical low output from a sensor.
